(19) United States
(12) Patent Application Publication
(10) Pub. No.: US 2002/0103801 A1
(43) Pub. Date: Aug. 1, 2002

(54) Centralized clearinghouse for community identity information

(76) Inventor: Martha L. Lyons, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/774,727

(22) Filed: Jan. 31, 2001

(51) Int. Cl. G06F 7/00

(52) U.S. Cl. 707/9

(57) ABSTRACT

The invention discloses a system and method for providing a centralized repository for reputation, ratings, and identification data of any participating user. The user earns a reputation or other ratings information by interacting with outside organizations or Internet participation communities. The reputation or other ratings information is then preferably categorized and stored in the inventive clearinghouse database. The user and/or the participation communities may access the clearinghouse after proper verification to upload, update, or download any of the user's reputation information when authorized to do so by the user. The centralized format preferably allows the user to transport any ratings or reputation data from one community to another while preserving the integrity and reliability of the information.

### BACKGROUND

Over the last five to ten years, the Internet has spawned a variety of website communities in which accessing users may participate in any number of different activities, such as auctions, bartering, buying and selling, giving and receiving general advice, or giving and receiving specialized or professional advice. Because of its inherent anonymity, the security of transactions, as well as the reliability of any advice over the Internet, becomes questionable without some form of built-in protection.

Unlike some commercial Internet transactions with well-known web service providers, which may be secured using standard encryption and secure sockets layering technologies, transactions or advice occurring between Internet users may not typically be secured or guaranteed using the same technologies. In order to increase the reliability of such Internet transactions, web service providers have generally developed user rating processes for building site-specific user reputations for users participating in the offered services.

In one example, eBay, Inc., an on-line auction service, maintains an extensive user-“reputation” database that generally allows one user to check the “reputation” of a potential buyer or seller. Users typically “earn” the reputation by participating in auctions, either as a buyer or seller, on the website. If one user generally does not timely pay winning bids or send auctioned items, that user will typically build a negative reputation. Other users accessing eBay would then generally be able to see that the one user would not typically be a good party to get involved in a transaction with. Conversely, users may build up a good reputation by routinely offering good items, paying or sending the goods promptly, etc.

Other web services may include exchanging technical information or advice between users. Advice or information received from a junior high school student posing as a registered professional engineer, certified network administrator, or even an attorney will typically not be as credible or reliable as it would from an actual engineer, certified network administrator, or attorney. Some such advice websites may also utilize user reliability ratings based from a point system in which points are awarded by users or the web service provider for correct information or advice given. Thus, participating users with a high number of rating points may generally be seen by other uses as reliable, while participating users with a low number may generally be seen either as unreliable or as not having extensive interaction with the particular website service.

One of the problems with the current methods used to provide a user reputation information on Internet communities is that there are typically no means for users to verify certifications, registrations, or degrees that other users hold themselves out as having.

Another problem with the current methods is that a user may not generally transport his or her reputation from one service community to another. For example, if a user spends a few years building a good reputation on eBay, he or she will usually not be able to transport that reputation or persona identity information to another auction website such as Yahoo! Auction or Amazon.com Auctions. This user may then have his or her bids rejected because of the lack of a reputation. Similarly, in an advice community, a user with a good advice reputation may not generally be perceived as reliable if he or she tries a new advice community.

It would therefore be desirable to have a reputation clearinghouse for gathering user reputation or identity reliability information. Users would then be capable of “transporting” their reputation information between different communities.

### SUMMARY OF THE INVENTION

The present invention is directed to a system and method for providing a centralized repository of reputation or reliability information which may preferably be shared or transported between different subscribing user participation communities. A preferred embodiment of the present invention provides a reputation authority for electronically storing reputation information relating to a participating user. The reputation authority would preferably have a database, for storing the reputation information, security measures, for verifying the identities of any user or subscribing community organization attempting to establish a connection with the authority, and a communication system, for receiving the reputation information and then transmitting the information to a subscribing community organization after receiving authorization from a participating user, either directly or indirectly. The reputation authority would also preferably have a certification engine, for certifying the authenticity of the transmitted reputation information.

The preferred method for providing such a centralized repository of reputation or persona rating information would preferably include verifying the identity of an associated member-user and/or accessing third party in response to a request to access the repository. After verifying the identity of the member-user or accessing third party, the repository preferably receives persona rating information from the member-user and/or the accessing third party. The repository would then preferably store the persona rating information in a database indexed according to an identifying characteristic of the member-user, such as a user ID, a name, number, or the like. The repository would then preferably deliver selected portions of the persona rating information to the accessing third party in response to the member-user's authorization. As the information is being delivered or sent, the repository would preferably attach a certification of the authenticity of the transferred information. This certification would advantageously provide verification that the persona information is related to a particular member-user, and that it is being transmitted by the repository.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a block diagram illustrating a typical configuration of the prior art system for Internet participation communities;

FIG. 2 is a block diagram illustrating a preferred embodiment of the present invention configured to provide centralized information to a single participation community;

FIG. 3 is a block diagram illustrating a preferred embodiment of the present invention configured to provide centralized information to multiple participation communities; and

FIG. 4 is a flow chart illustrating the steps performed by a preferred embodiment of the present invention.

### DETAILED DESCRIPTION

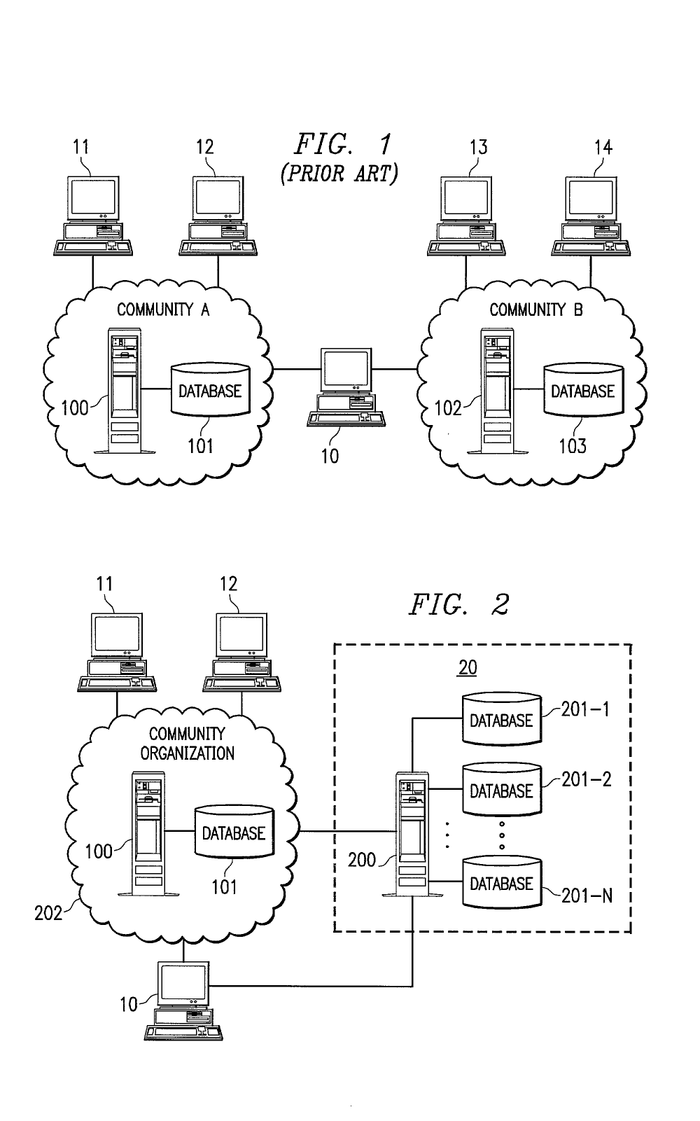

Community participation websites generally attempt to increase security reliability at their sites by establishing a database of reputation, identity, or reliability information associated with each user of the service. FIG. 1 illustrates such a system. For purposes of this example, Communities A and B will be considered both auction sites. Community A is centered around server 100 and database 101, while Community B is centered around server 102 and database 103. As users 10-12 access Community A, they each build a reputation based on the transactions that each completes. This reputation information is then stored by Community A in database 101 for access by the community system. If user 12 is considering a transaction with subscribing user 10, user 12 may view subscribing user 10's reputation by accessing the reputation data in database 101.

If subscribing user 10 desires to participate in auctions at Community B, subscribing user 10's reputation data remains on Community A's database 101. As subscribing user 10 accesses Community B through server 102, Community B users 13 and 14 may not typically view subscribing user 10's full reputation as developed in Community A. Users 13 and 14 may generally only access subscribing user 10's reputation rating resident on database 103. If subscribing user 10 had not participated in many auctions or other activities on Community B, and thus had little reputation information stored on database 103, users 13 and/or 14 may be disinclined to deal with subscribing user 10.

In the preferred embodiment of the present invention shown in FIG. 2, subscribing user 10 subscribes to reputation authority 20 for centralizing all of subscribing user 10's reputation or identity attributes. Subscribing user 10 may belong to or participate in many different community organizations. These community organizations may also typically subscribe or register with reputation authority 20 to participate in the present invention. Any reliability or reputation data that subscribing user 10 builds in these different registered community organizations is preferably stored in reputation authority 20 in one or more of databases 201-l-201-N. Server 200 preferably categorizes all of the reputation information earned by subscribing user 10 into predefined categories and/or classifications. Server 200 stores the reliability information according to those predefined categories and indexes the information according to the particular associated user (i.e., subscribing user 10). These categories or classifications correspond to the reliability or reputation information that would typically go along with any class of community organization. For example, in auction sites, the quality of goods subscribing user 10 typically places up for auction in addition to subscribing user 10's payment or shipping history would provide useful background concerning subscribing user 10's auction reputation. However, this information may generally be unimportant to a participation community that deals with technical advice or match-making. Other categories of information regarding subscribing user 10 would be more beneficial for those other communities.

It should be noted that the reputation or reliability information is not limited to a simple numeric “score” or rating. Alternative embodiments of the present invention would incorporate the storage and processing capabilities to handle both freeform textual comments and even audio or video clips of user feedback. In such alternative embodiments, a user may be able to write a detailed assessment of the participating user's reliability or reputation. Furthermore, users would also be able to give verbal assessments, comments, or feedback on the target participating user. The user may also be able to record video comments on the target participating user. The participating user could also respond to comments or reliability and reputation information with freeform text or audio clips. The persona identity or reputation data is not limited to only be compiled by other users or the subscribing participation community.

Server 200 would then preferably use an information classifier to group the class of rating information into related groups relevant to the particular community activity. Participation communities, such as registered community organization 202, would then preferably access reputation authority 20 to receive subscribing user 10's reputation data connected to the activity of registered community organization 202. Thus, if registered community organization 202 were an auction site, the quality of goods, payment, and shipping history of subscribing user 10 in the “auction” category on databases 201-l-201-N would preferably be accessible to registered community organization 202. Conversely, if registered community organization 202 were a technical advice website, subscribing user 10's identity attributes in the “tech” category would preferably be accessible to registered community organization 202.

It should be noted that reputation authority 20 may also preferably define several general categories of reputation data accessible by all participation communities. Items such as geographic location, educational background, and the like, may be useful for a participating community to calculate additional ratings or reputation qualities according to some proprietary algorithms.

In order to protect the integrity of subscribing user 10's reputation, reputation authority 20 preferably includes identification verification measures to verify that subscribing user 10 is subscribing user 10 and/or that registered community organization 202 is registered community organization 202. Therefore, before server 200 stores, sends, or allows access to any category of persona or reputation information, the identity of each subscribing community or user is preferably verified. Such measures may include, but are not limited to, digital certificates, passwords, handshake sequences, or the like.

Moreover, subscribing user 10 is preferably given the authority to control the dissemination of his or her reputation or persona identity information in the preferred embodiment of the present invention. Thus, server 200 will preferably not allow access to any of subscribing user 10's identity attributes unless it first has an authorization from subscribing user 10. Such authorization may preferably be given directly by subscribing user 10 to reputation authority 20, or may preferably be given by subscribing user 10 to registered community organization 202, which then advantageously uses the authorization to gain access to server 200 and databases 201-l-201-N. Once registered community organization 202 has been granted access to the appropriate class(es) of reputation or persona identity information, server 100 preferably processes the information and stores it in local database 101. Now, users 11 and 12 may preferably view subscribing user 10's reputation information from database 101 even if subscribing user 10 had never participated in any activities with registered community organization 202.

In order to assure that the reputation information is kept accurate, registered community organization 202 may independently access reputation authority 20 in order to age or update the reputation information in databases 201-l-201-N. As registered community organization 202 accumulates new reputation information from interactions with subscribing user 10, the new reputation information may be delivered back to reputation authority 20. The process may preferably be triggered either by a polling mechanism from reputation authority 20, by update periods controlled by registered community organization 202, or by update periods controlled by subscribing user 10.

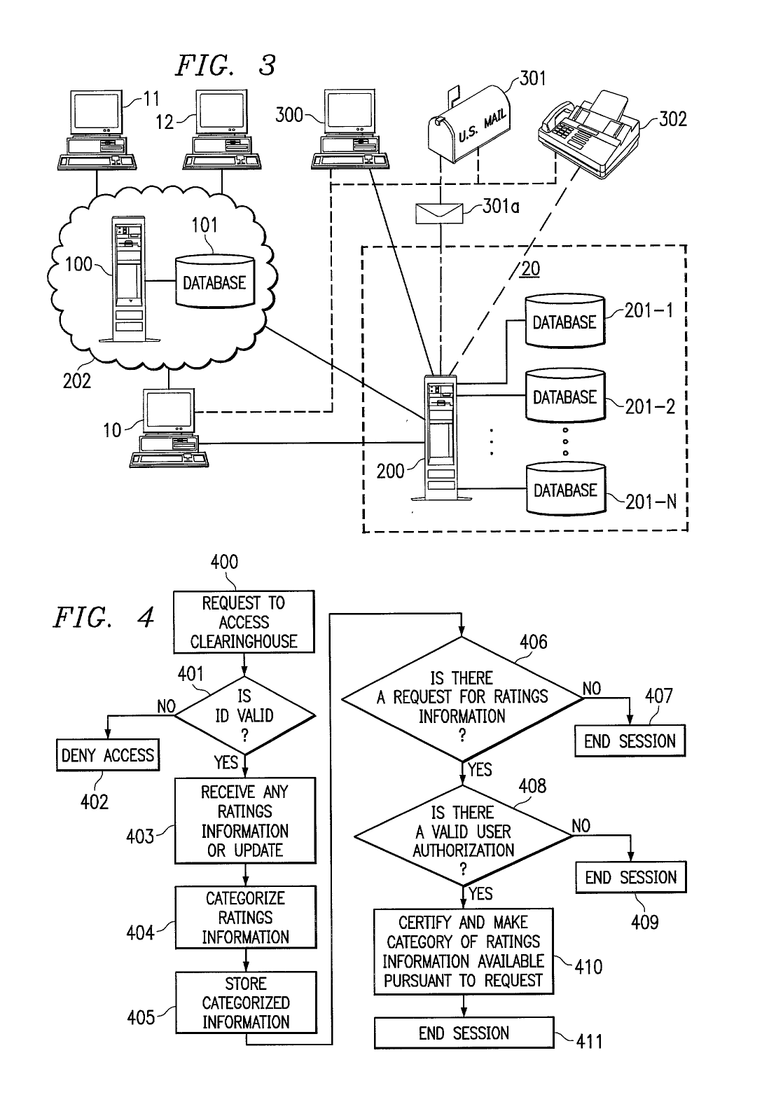

Alternative embodiments of the present invention are preferably not limited only to Internet applications. FIG. 3 illustrates an alternative embodiment of the present invention configured to provide rating or reputation information to multiple participation communities regardless of the communities existence or connection to the Internet. In FIG. 3, users 10-12 interact in the same manner with registered community organization 202 as described with respect to FIG. 2. Ratings information from reputation clearinghouse 20 is preferably shared and processed by server 100 for storage in database 101. However, FIG. 3 includes three additional participating communities 300-302. Participating community 300 maintains Internet access through a general purpose computer, but does not provide a web-based service community. Participating community 301 either chooses not to have Internet access or does not use the Internet for obtaining information on members of users of its services, relying instead on U.S. mail or overnight delivery service. Participating community 302 may be a small community which relies on facsimile communication for gathering information or ratings on prospective customers or users.

In operation of the alternative embodiment of the present invention, subscribing user 10 participates in activities with each of participating communities 300-302. Because the communities do not necessarily have to be connected to the Internet, subscribing user 10 may preferably participate using a telephone, facsimile, or even participate in person. As subscribing user 10 desires to have reputation information delivered to participating communities 300-302, he or she may preferably initiate delivery of selected persona identity rating information from databases 201-l-201-N. Furthermore, as participating communities 300-302 compile continuing reputation information, each of communities 300-302 may preferably deliver updates of reputation information to reputation management clearinghouse 20 to age the reputation information stored in databases 201-l-201-N.

In a first alternative embodiment, subscribing user 10 may preferably establish a connection with reputation management clearinghouse 20 to give direct authorization for sending the selected persona identity information. As a part of this authorization, subscribing user 10 may preferably supply reputation management clearinghouse 20 with an e-mail or other electronic address for participating community 300. Subscribing user 10 may also preferably supply clearinghouse 20 with a postal address for participating community 301. Finally, subscribing user 10 may preferably provide a facsimile number for participating community 302. Subscribing user 10 would also preferably provide clearinghouse 20 with the selections of ratings categories to provide to each of participating communities 300-302.

Server 200 would then preferably use the information provided by subscribing user 10 to compile the necessary identity attributes and place the data in the appropriate format for delivery. Server 200, thus, preferably generates an e-mail for participating community 300. It preferably produces letter 301 a using a letter printer (not shown), which is then automatically mailed through a selected delivery means. Server 200 would then preferably fax the appropriate reputation or ratings information to the facsimile number supplied by subscribing user 10. Server 200 would advantageously incorporate a verification symbol or digital certificate on each of the selected forms of ratings information in order to authenticate the information delivered to participating communities 300-302.

In this first alternative embodiment, identity verification is preferably completed by subscribing user 10. Clearinghouse 20 may preferably verify subscribing user 10's identity through digital certificate. The delivery information provided by subscribing user 10 may be presumed to be correct, as it comes directly from subscribing user 10.

In a second alternative embodiment of the present invention, the subscribing communities may preferably directly contact clearinghouse 20 using an authorization code provided by subscribing user 10. In such an embodiment, subscribing user 10 could preferably supply participating community 300 with a specialized web address, which is associated with the selected category of subscribing user 10's reputation information desired for delivery. As participating community 300 accesses the special web address, subscribing user 10's authentication code may preferably be entered. This code would preferably initiate the automatic generation of an e-mail to the accessing computer's e-mail address of participating community 300.

It should be noted that in an alternative embodiment a user could provide authentication to the clearinghouse prior to the registered third party community attempting access. In such an embodiment, as the registered third party requests access to the clearinghouse, the reputation management clearinghouse searches its own records for the user's authorization.

For participating community 301, subscribing user 10 could preferably either supply another specialized web address which would require participating community 301 to enter the appropriate mailing address, or supply a special phone number to call for access to an interactive voice response (IVR) unit (not shown) connected to server 200. The IVR could preferably elicit the necessary subscribing user 10 authentication code and mailing address of participating community 301. Using this information, server 200 would preferably generate letter 301a using an automatic letter printer (not shown).

For participating community 302, subscribing user 10 could preferably supply either the specialized web address or phone number to the clearinghouse IVR (not shown). The IVR or website could then preferably elicit subscribing user 10's authentication code and participating community 302's facsimile number. Alternatively, participating community 302 could preferably dial a specialized fax number which uses the dialed number identification service (DNIS) to cross-reference subscribing user 10's authentication rating information or selected reputation categories. Once this information was secured, server 200 could then preferably use participating community 302's facsimile number obtained from the automatic number identification (ANI) service to initiate a facsimile of the appropriate ratings information from databases 201-l-201-N.

In practice, subscribing user 10 may preferably be able to e-mail, fax, or mail certified records of everything from degrees, certifications, licenses, and professional registrations to payment histories, dating preferences, and even golf handicaps. Clearinghouse 20 would then preferably become a central information management system for subscribing user 10 to manage any identity attributes, reliability, or reputation information gathered through almost every aspect of life.

Participating communities 300-302 may also update and age the reputation information stored in databases 201-l-201-N. The reputation information gathered by communities 300-302 may preferably be delivered to reputation management clearinghouse 20 using various different methods such as mail, e-mail, or facsimile. This update information may then preferably be entered, scanned, or recorded by clearinghouse 20 for storage into databases 201-l-201-N to age the reputation therein.

FIG. 4 provides a flow chart of the basic steps executed in typical sessions with a preferred embodiment of the present invention. Of course, prior to any sessions as illustrated in FIG. 4, the user and any accessing third party may typically register or subscribe to the reputation clearinghouse for the inventive service. At step 400, a request is made to access the reputation clearinghouse. This request may come from a participating user or some other subscribing third party. Security measures are preferably activated at step 401 to verify the identification of the party requesting access to the system. If the reputation clearinghouse cannot verify the requesting party's identification, access is preferably denied in step 402. If, however, the identification is valid, reputation clearinghouse preferably receives any persona or reputation information or updates in step 403. Such information may preferably be exchanged or, at least prompted for, with every access to the reputation clearinghouse. Therefore, if a subscribing third party is connecting to the clearinghouse, any new reliability information accumulated by the subscribing third party would preferably be downloaded into the clearinghouse database. The downloaded reliability information would then preferably be categorized by the clearinghouse in step 404, and stored in the databases in step 405.

Step 406 preferably determines whether the accessing party desires to obtain any ratings information from the clearinghouse. The clearinghouse would not necessarily be accessed every time to obtain ratings information. For example, a participating user may preferably access the clearinghouse to directly provide authorization to send reputation or persona information to a registered third party or participation community. However, a participating user would not typically need to access his or her own information. Similarly, a registered third party community may have been directed by the subscribing user to update the ratings information at the clearinghouse. The subscribing community would, therefore, preferably access the clearinghouse only to download the latest reputation information earned by the user on that community. If access to the rating information is not desired, the session is preferably ended at step 407.

If the accessing party wishes to obtain rating information, the reputation clearinghouse will first preferably verify if there is a valid authorization from the subscribing user at step 408. If no valid authorization has been presented, the session is preferably ended at step 409. A subscribing user's authorization may preferably be provided by the user directly to the reputation clearinghouse, or may alternatively be given to the registered third party, which would then preferably present the subscribing user's authorization to the clearinghouse. If a valid user authorization does exist, then the reputation clearinghouse preferably makes the reputation information available to the registered third party at step 410. The information may preferably be made available by allowing the third party to “read” the information, or alternatively, it may be made available by downloading the electronic information from the clearinghouse databases to the registered third party. After the information has been exchanged, the session is preferably ended at step 411.

It should be noted that although the examples of preferred and alternative embodiments herein have described a reputation authority providing information or access to identification or reputation information only on the authorization of a user, the present invention is not so limited. Alternative embodiments may comprise a relationship between the reputation authority and subscribing participation communities directly. The users rating information would preferably be freely exchanged between the subscribing communities and the centralized ratings authority. The authority and subscribing participating communities could then preferably decide how much access to the reputation information to allow the user.

It should also be noted that alternative embodiments of the present invention do not add the step of categorizing the information into topical groups. Such alternative embodiments would preferably store the whole of raw ratings information into a database indexed by the users identification.

It should also be noted that although the embodiments described herein have indicated that an accessing community would only have access to limited reputation information, it should be appreciated that alternative embodiments of the present invention would allow all participating communities access to all available persona identity or reputation data stored within the reputation authority.

It should further be noted that the subscribing “users” of the present invention may include individuals as well as organizations or companies. Organizations could preferably build reputation information which could then be advantageously shared among different communities in which the organization participates.

It should further be noted that subscribing users may build reputations by purchasing bonds with the reputation authority. In applications involving buying or selling, such bonds may act as insurance against losses.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A reputation authority for electronically storing reputation information relating to a user comprising:
a database for storing said reputation information;
security measures for verifying identities of at least one of said user and a plurality of community organizations; and
a communication system for receiving said reputation information and transmitting said reputation information to said plurality of community organizations responsive to an authorization received by said user.

2. The reputation authority of claim 1 wherein said reputation information comprises at least one of:
information related to activities of said user;
information related to qualifications of said user; and
information related to reliability of said user.

3. The reputation authority of claim 1 further comprising:
a certification engine for certifying authenticity of said transmitted reputation information.

4. The reputation authority of claim 1 further comprising:
a reputation information classifier for grouping pieces of said reputation information into predetermined categories related to activities conducted with said plurality of communication organizations.

5. The reputation authority of claim 4 wherein said plurality of community organizations receives said reputation information in categories related to said activities conducted on said plurality.

6. The reputation authority of claim 1 wherein said user authorization is provided by said user to said plurality of community organizations for retrieving said reputation information from said reputation authority.

7. The reputation authority of claim 1 wherein said user authorizes said reputation authority to transmit said reputation information to said plurality of community organizations.

8. The reputation authority of claim 1 wherein at least one of said user and said plurality of community organizations subscribes to said reputation authority in order to participate in said electronically storing reputation information.

9. A method for providing a centralized repository of identity attributes comprising the steps of:
verifying an identity of one of an associated user and an accessing third party responsive to a request to access said centralized repository;
receiving said identity attributes from at least one of said verified associated user and said verified accessing third party;
storing said identity attributes in a database indexed according to said verified associated user; and
delivering at least one set of said identity attributes to said verified third party responsive to an authorization received from said verified associated user.

10. The method of claim 9 wherein said storing step includes the step of:
categorizing said identity attributes into sets related to activities of said accessing third party.

11. The method of claim 10 wherein said at least one set comprises said sets related to activities of said accessing third party.

12. The method of claim 9 further comprising the step of:
processing a request for said at least one set of identity attributes from said accessing third party, wherein said associated user provides said authorization to said accessing third party.

13. The method of claim 9 further comprising the step of:
updating said stored identity attributes from at least one of said associated user and said accessing third party; and
certifying said at least one set of said identity attributes.

14. The method of claim 9 further comprising the step of:
registering at least one of said associated user and said accessing third party with said centralized repository of identity attributes for receiving prior to said verifying step.

15. A reputation management clearinghouse comprising:
means for verifying an identity of one of a plurality of users and a plurality of participating user communities responsive to a request to access said clearinghouse;
means for storing reliability data from one of said verified plurality of users and said verified plurality of participating user communities;
means for associating said stored reliability data with an associated user; and
means for releasing selected reliability data to one of said verified plurality of participating user communities responsive to consent given by said associated user.

16. The reputation management clearinghouse of claim 15 further comprising:
means for updating said stored reliability data from at least one of said plurality of users and said plurality of participating user communities.

17. The reputation management clearinghouse of claim 15 wherein said means for storing includes:
means for classifying said reliability data into groups related to activities of said plurality of participating user communities.

18. The reputation management clearinghouse of claim 17 wherein said selected reliability data comprises said groups related to activities of said plurality of participating user communities.

19. The reputation management clearinghouse of claim 15 further comprising:
means for processing requests for said selected reliability data from said plurality of participating user communities, wherein said verified one of said plurality of users provides said consent to said plurality of participating user communities.

20. The reputation management clearinghouse of claim 15 further comprising:
means for processing a request to deliver said selected reliability data from said verified one of said plurality of users, wherein said verified one of said plurality of users provides said consent to said reputation management clearinghouse.
